(19) United States
(12) Patent Application Publication
(10) Pub. No.: US 2012/0016808 A1
(43) Pub. Date: Jan. 19, 2012

(54) Business Review and Volume Optimizer (BRAVO)

(75) Inventors: Vipin K. Ramani, Charlotte, NC (US); Michael D. Conley, Charlotte, NC (US); Karen E. Krastev, Pacifica, CA (US); Brian R. Whitaker, Charlotte, NC (US); Daniel J. Malouff, Thousand Oaks, CA (US)

(73) Assignee: BANK OF AMERICA CORPORATION, Charlotte, NC (US)

(21) Appl. No.: 12/837,664

(22) Filed: Jul. 16, 2010

(51) Int. Cl. G06Q 40/00

(52) U.S. Cl. 705/36 R

(57) ABSTRACT

An optimization engine is provided to determine, through price optimization modeling, an optimal combination of price and volume for various products and services of an organization while also considering numerous factors internal and external to the organization. The price optimization modeling provided by the optimization engine may, among other things, be used by the organization to determine the optimal set of pricing recommendations that will provide the organization with the highest total contribution margin (total revenue less total variable cost). The optimization engine may consider various data inputs and analytics that allow an organization to develop a more effective and disciplined price-decisioning process.

### FIELD

Aspects of the disclosure relate to optimization modeling. More specifically, aspects of the disclosure relate to an optimization process for determining an optimal combination of business variables to maximize margin revenue.

### BACKGROUND

In developing an overall business strategy, an organization, especially a financial institution, has many different objectives that it hopes to achieve through the various products and services that the organization offers to its customers. One such objective is to maximize the organization's total contribution margin (e.g., total revenue less total variable cost). While many variables contribute to attaining this objective, determining an optimal combination of price and volume for the organization's products is particularly important.

An organization driving forward with a strategy of maximizing total margin revenue must ultimately develop and follow some form of price optimization. In very simplistic terms, optimization is the process of choosing the permissible actions that result in the most favorable outcome. A number of factors can influence the degree to which optimization succeeds. For example, the freedom to take actions that produce the best results may not exist; there may be incomplete or incorrect information about how various actions interact with each other, how such actions are limited by circumstances, or how such actions influence the possible outcomes. In some cases, the choice of permissible actions may be so large that it is impossible to evaluate all of them. Additionally, the outcome resulting from a choice of actions may be inaccurately measured, or there may not even be a reliable way to determine if a particular outcome is close to being the best outcome.

### BRIEF SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

To address some of the aforementioned difficulties that plague informal, intuitive, unstructured attempts at optimization, an organization (e.g., a financial institution) desiring to maximize its revenue return must take a disciplined approach to optimizing a solution to a well-defined decision problem, such as determining the best combination of price and volume for its particular products and services. Doing so can mitigate or eliminate many of the difficulties described.

According to one or more aspects described herein, an optimization model is provided to determine an optimal combination of price and volume for various products and services of an organization while balancing numerous factors internal and external to the organization. The optimization model may be implemented through an optimization engine (e.g., a computer) which, among other things, may be used to generate pricing recommendations for the organization to evaluate in implementing a strategy for maximizing total contribution margin (total revenue less total variable cost).

According to another aspect described herein, the optimization engine considers several data inputs and analytics that allow the organization to develop more effective and disciplined approaches to making business decisions. For example, the optimization engine may utilize measurement data related to the organization's competitive position in the marketplace, calculated revenue margins per product that indicate how cost-behavior impacts profitability for the organization, and consumers' response to a change in the organization's competitive position, measured in terms of market share.

According to other aspects described herein, the optimization engine may identify an optimal competitive position at which the organization's profit margin and market share goals may be met while conforming to one or more business constraints. Such constraints may include, for example, the organization's reputation, margin ceilings and floors, margin forecasts, stability of the market, and channel pricing parity.

According to another aspect described herein, outputs from the optimization engine may be used by the organization as input recommendations for making actual pricing decisions in support of an overall business strategy for maximizing the organization's total contribution margin. Such pricing recommendations may require adjustments or may need to be deviated from to account for various disparities, additional constraints, and/or anomalies associated with the optimization model and optimization engine described herein.

Aspects of the disclosure may be provided in a computer-readable medium having computer-executable instructions to perform one or more of the process steps described herein.

This summary is provided to introduce a selection of aspects of the disclosure in a simplified form that are further described below in the Detailed Description and accompanying figures. The summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is a flowchart illustrating an example method for optimization modeling according to one or more aspects described herein;

FIG. 4 is a flowchart illustrating an example method for determining an optimal pricing recommendations according to one or more aspects described herein;

FIG. 5 illustrates an example data flow diagram for collecting input data and generating output reports according to one or more aspects described herein;

### DETAILED DESCRIPTION

In the following description of various illustrative embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

By way of general introduction, aspects described herein relate to an optimization process for determining an optimal set of pricing recommendations for an organization (e.g., financial institution, investment services company, business entity, etc.) to use when implementing actual pricing decisions. The process is designed according to an optimization model that utilizes key data and analytics relevant to the organization to determine optimal combinations of price and volume for products of the organization that maximizes margin revenue while balancing market share growth and offering a fair and transparent price to the customers (consumers, users, clients, customers, etc.). In at least one arrangement, the optimization model described herein utilizes three primary inputs—Relative Strength Index (RSI), Variable Contribution Margin (VCM) and Price Elasticity—to determine optimal combinations of price and volume for various mortgage products of the organization while balancing numerous factors internal and external to the organization. As described herein, the optimization model is executed by an optimization engine configured to conduct computationally-based iterative processing with the model to identify actions (e.g., pricing positions) that will produce optimal results, such as maximized margin revenue, while operating under specific constraints. Incorporating the use of the optimization engine into the overall optimization process described herein enables the organization to take a well-defined and disciplined approach to determining optimal pricing solutions, while eliminating many of the difficulties associated with unstructured optimization techniques.

Although aspects of the optimization process and model described herein are provided in the context of determining optimal pricing for an organization's mortgage products, the optimization process and model may also be applied in numerous other contexts related to an overall business strategy for maximizing total contribution margin (e.g., total revenue less total variable cost) for an organization. For example, the optimization model may be used to determine an optimal level of risk for an organization to accept, an optimal number of customer accounts for the organization to manage without over-utilizing its resources, as well as an optimal amount of resources to be maintained by the organization to minimize waste. It should be understood that the optimization process and model described herein may be applicable in additional contexts similar to those discussed above.

Other aspects of the disclosure relate to the optimization engine collecting certain measurement data from various source systems and mapping tables, extracting the data from its native format into a common format, manipulating (e.g., cleansing, repairing, excluding, removing, etc.) any items of data that may be incomplete or contradictory, and then storing or warehousing the data for centralized access. The stored data may then be used by the optimization engine in executing the optimization model to generate a variety of outputs including pricing recommendations, forecasting reports, summary notes, and other analytical tools that may be used by the organization to make informed decisions regarding its overall business strategy. The optimization engine may generate such outputs in a manner that provides the organization with an aggregate view of the various pricing recommendations, performance measurements, and forecasting models associated with its products.

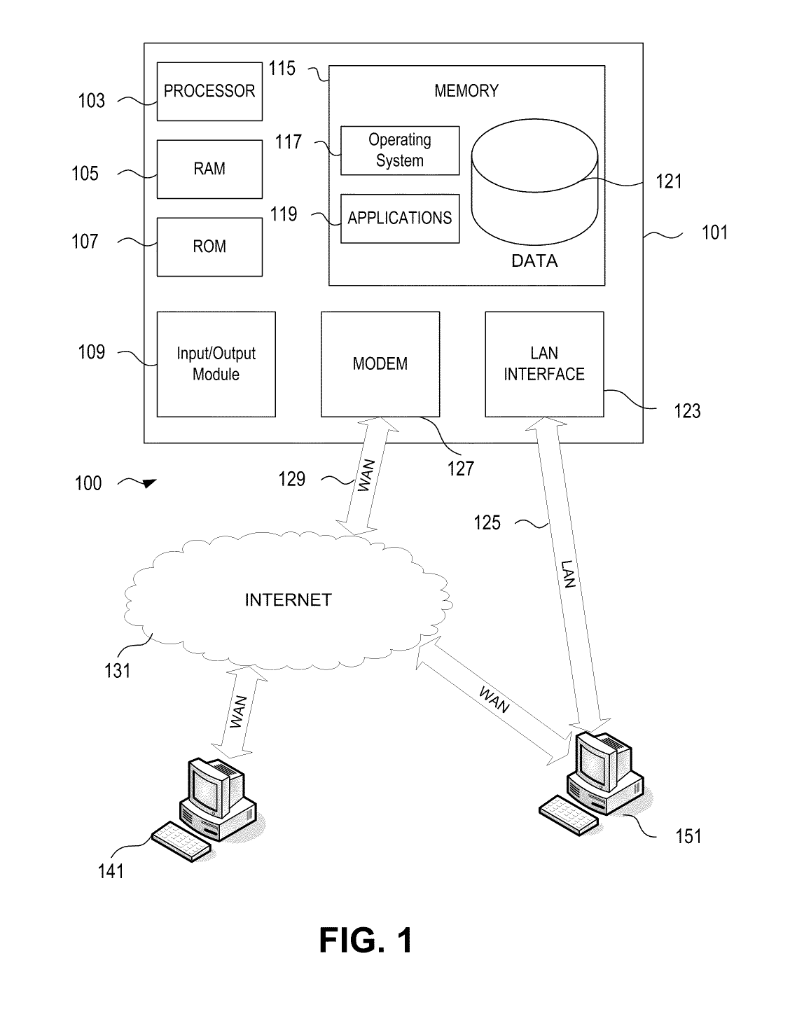

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, Input/Output (I/O) Module 109, and memory 115.

I/O Module 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

Server 101 may operate in a networked environment 100 supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. Furthermore, any of a number of different communication protocols, such as TCP/IP, Ethernet, FTP, HTTP and the like, may be used within networked environment 100, and the system can be operated in a client-server configuration to permit a user to retrieve web pages from a web-based server. Any of various conventional web browsers can be used to display and manipulate data on web pages.

Additionally, an application program 119 used by the server 101 according to an illustrative embodiment of the disclosure may include computer executable instructions for invoking functionality related to implementing optimization modeling to determine optimal combinations of price and volume for products of an organization.

Computing device 101 and/or terminals 141 or 151 may also operate in mobile terminals (e.g., notebooks, PDAs, etc.) communicating over a wireless carrier channel (not shown) and include various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

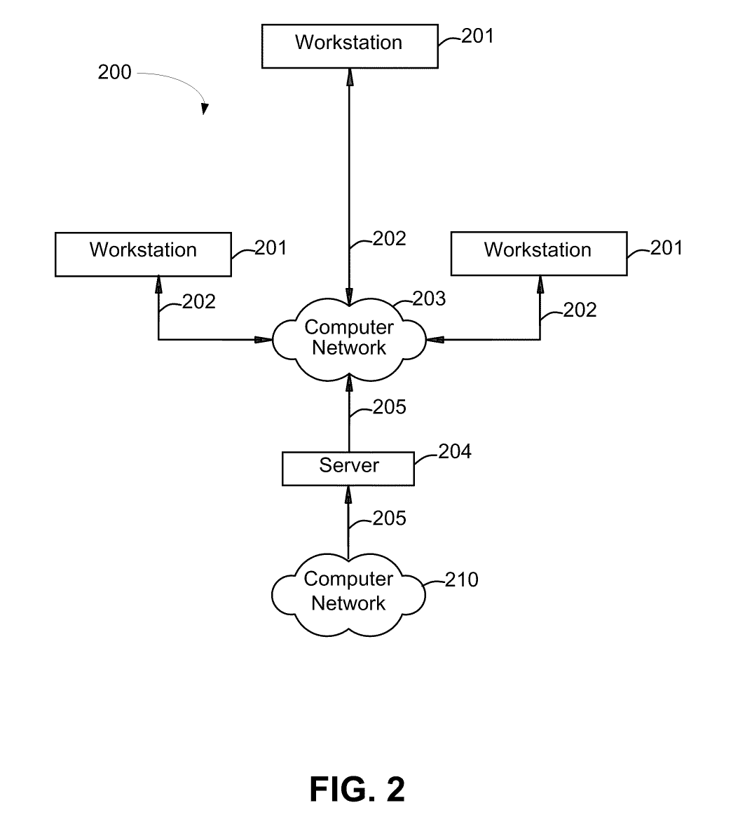

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

In at least one arrangement the optimization model described herein utilizes three primary data inputs to determine optimal combinations of price and volume for various mortgage products (e.g., loans, mortgages, bonds, etc.) of an organization (e.g., a financial institution) while balancing numerous factors internal and external to the organization. In one example, such internal and external factors may be referred to as business constraints (e.g., business rules, parameters, limits, etc.). As mentioned, while aspects of the optimization process are described in the context of a financial institution desiring to determine optimal pricing positions for certain financial products, it should be understood that the optimization process described herein may be practiced in a variety of industries and with a variety of products and services in addition to or instead of those mentioned. Furthermore, although aspects of the present disclosure are described within the context of price optimization, the optimization process described herein may be applied to achieve other objectives in addition to or instead of maximizing revenue and determining an optimal pricing position for products of an organization. Accordingly, it should be understood that reference to price optimization is not intended to limit the scope of the disclosure in any way.

Furthermore, aspects described herein refer to numerous metrics for quantifying the inputs, outputs, components and performance of the optimization model. These metrics are designed to be utilized by the optimization engine as part of an overall business strategy of maximizing revenue return. Such metrics may be designed to work well under wide ranging scenarios and business conditions, and thus should not be limited by the exemplary identifiers or computational descriptions included herein.

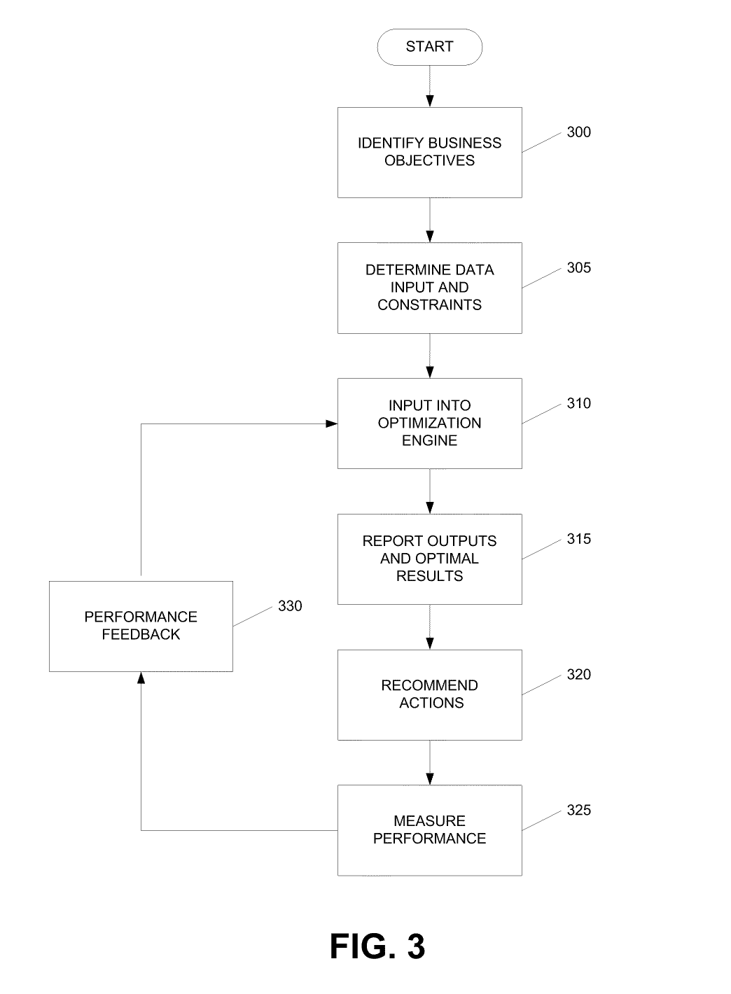

In at least one arrangement, executing the optimization model using the optimization engine may constitute one component or part of a larger overall process or system of the organization. Such an arrangement is illustrated in FIG. 3, where the optimization engine described herein plays a major role in only one of seven larger overall process steps. The optimization process shown in FIG. 3 may, in one or more arrangements, be an automated process whereby the various functions and operations described herein with respect to the optimization engine may also be carried out in an automated fashion. The example optimization process shown in FIG. 3 may be designed to provide an organization with the highest revenue return while also meeting market share goals and ensuring fair customer pricing. The various steps outlined in FIG. 3, which will be described in greater detail below, include identifying business objectives 300, determining data input and constraints 305, inputting the data and constraints into the optimization engine 310, reporting the outputs and results of the optimization engine 315, using the outputs and results to develop recommended actions 320, and measuring the performance of such recommendations 325.

Additionally, while optimization modeling includes building and solving a model so as to produce an optimal solution, analysis is still necessary to determine whether the solution produced is suitable for the original business problem. In conducting such an analysis it is not unusual to discover that a key element of the model has been overlooked or misconstrued, rendering the optimal solution (and the decisions that it represents) unsuitable. For example, the model might be correct, but the data being utilized by the model might be incorrect. Another possibility is that the understanding of the original business problem is flawed. In these and other cases it is necessary to step back through the modeling process, address the difficulty, and then move forward with the improved model. Accordingly, a performance management-based iterative process may be incorporated into the optimization process illustrated in FIG. 3 through a feedback loop 330. In one or more arrangements, feedback loop 330 may provide an organization with opportunities for regular pricing realignment to account for variances in market conditions while maintaining a strategic balance with internal and external factors.

The steps outlined above represent a simplified explanation of one possible approach to developing a complete price optimization process in support of an overall strategy to maximize total margin contribution (total revenue less total variable costs) for an organization. Numerous alternative approaches may also be used in conjunction with the various aspects described herein related to implementing an optimization model via an optimization engine (e.g., a computer) to determine optimal pricing actions. The price optimization process described above is intended to provide a context within which the various aspects described below may be practiced, and is not intended to limit the scope of the present disclosure in any way.

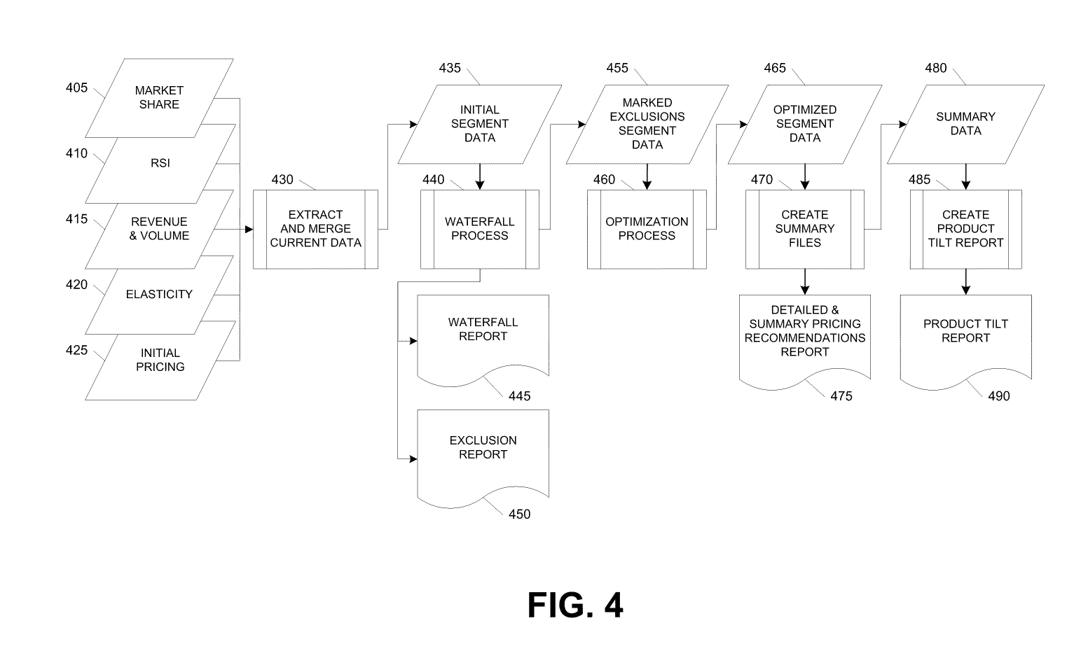

FIG. 4 is a high-level process diagram illustrating an example price optimization method and system according to one or more aspects described herein. As shown in FIG. 4, the optimization method and system comprises the main steps of extracting and merging current data 430 that is to provide the input for the optimization engine, running the extracted and merged data through a waterfall process 440 to ensure that the data is complete and in condition to be optimized, executing the optimization process on the data 460 to determine optimal combinations of pricing and volume, which includes subjecting the data to the optimization model executed via the optimization engine, creating summary files and datasets 470 using the optimized data, and using the summarized data to create a product tilt report 485.

As mentioned above, numerous metrics are referred to herein for quantifying various components of the optimization process. For example, certain data and analytics are utilized as input for the price optimization method shown in FIG. 4, including, for example, market share 405, RSI 410, revenue and volume 415, elasticity 420, and initial pricing 425. The details of these data inputs are described in greater detail below. Following the input datasets undergoing the extract and merge current data step 430, the process outputs initial segment data 435. As used herein, a “segment” may be a product (e.g., a loan) defined by purpose, sales channel, geographic state, and relevant product group. For example, a financial institution desiring to optimize pricing for consumer mortgages and home equity may have segments defined by loan purpose (e.g., purchase loan, refinance loan, etc.), sales channel to which the loan belongs (centralized sales, distributed retail sales, wholesale sales, e-channels, etc.), state (all fifty States plus the District of Columbia), and applicable product group (e.g., government-related loans, agency loans, etc.). In such an instance, the financial institution may have upwards of ten-thousand segments that may be evaluated using the price optimization method and model described herein. Therefore, initial segment data 435 may include a substantial amount of data that has been extracted from various sources and merged together as described in greater detail below.

Similar to the initial segment data 435 output from the extract and merge current data step 430, segment data is also output following the waterfall process step 440 and the optimization process step 460. As shown, following the waterfall process step 440, which may be generally described as checking, through various iterative processes, the initial segment data 435 for completeness and ensuring that such data is in proper condition to be optimized, a second set of segment data is output. Specifically, marked exclusions segment data 455. Marked exclusions segment data 455 may, in one arrangement, include a subset of initial segment data 435 that was not excluded during waterfall process step 440 as a result of being incomplete or not complying with one or more constraints that form a part of the input for the price optimization method and system described herein. Various details of waterfall process 440 and the exclusionary criteria utilized therein are described in greater detail below. The marked exclusions segment data 455 is the segment data that is in proper condition to be optimized in the optimization process step 460, which outputs a third set of segment data, optimized segment data 465.

In at least one arrangement, optimized segment data 465 is data that has been optimized by the optimization engine according to the optimization model executed therein. Optimized segment data 465 may be used in the create summary files step 470 to create summary data 480, which, in at least one arrangement, includes one or more variations of segment data that was not part of the marked exclusions segment data 455 that underwent optimization in step 460. Summary data 480 may be used in the create product tilt report step 485. Various aspects of the steps and data comprising the price optimization method and system illustrated in FIG. 4 will be described in greater detail in the sections that follow. Additionally, aspects relating to the reports that may be generated as a result of the steps shown in FIG. 4, such as waterfall report 445, exclusion report 450, detailed and summary pricing recommendations report 475, and product tilt report 490, will also be described in further detail below.

The high-level process diagram of an example price optimization method and system illustrated in FIG. 4 may act as a reference guide in the following descriptions related to various detailed aspects of the disclosure.

As shown in FIG. 4, various data and analytics are utilized in the price optimization method and system described herein. In at least one arrangement, the key data and analytic elements utilized include Relative Strength Index (RSI) to make pricing decisions based on a broader set of competitive data, Variable Contribution Margin (VCM) to measure profitability, Price Elasticity (PE) to understand and measure the impact that competitive position has on consumer demand, and various performance measurements (e.g., feedback loop 330 illustrated in FIG. 3) to analyze strategic pricing decisions based on the pricing recommendations output from the optimization engine. As shown in FIG. 4, market share 405, RSI 410, revenue and volume 415, elasticity 420, and initial pricing 425, all broadly represent the aforementioned key data and analytics that may be used in determining an optimal pricing position that comports with various business constraints and rules relevant to the business of the organization (e.g., financial institution). It is to be understood that numerous other metrics, data and analytics may be used in addition to or instead of the example types mentioned above and described in further detail herein.

In describing certain aspects and components of the price optimization process illustrated in FIG. 4, references are made to various optimization modeling elements and categories. For example, the input data (e.g., market share 405, RSI 410, revenue and volume 415, elasticity 420, and initial pricing 425) shown in FIG. 4 may relate in one or more ways to certain defined “objectives,” “decision variables” and “constraints.” For purposes of optimization modeling, an “objective,” may be defined as the goal of the optimization process, or the end-result that is to be achieved. The objective must be measurable and may include, for example, maximizing profit, minimizing distance traveled, minimizing unused raw materials, and the like. Similarly, “decision variables” may be defined as numerical representations of the available actions or choices, such production levels, price settings, capital resource allocations, etc. Lastly, “constraints,” as used within optimization modeling, specify rules or requirements that place limits on how the objective can be pursued by limiting the permissible values of the decision variables. Examples of constraints include margin ceilings and floors, machine processing capacity per hour, customer demand by sales territory, budgetary restrictions, and other similar types of limits.

The following sections describe various aspects of the optimization process of the present disclosure within the optimization modeling framework outlined above. In particular, the following sections identify objectives, decision variables and constraints that, in one or more arrangements, comprise the core factors and input data for the optimization process.

### Objective Function

For an organization implementing an overall strategy of maximizing margin revenue while meeting market share goals and offering a fair price to customers, the “objective function,” which is the function to be maximized (or minimized), may be to:

### Maximize Revenue

With the objective function defined, it may be applied using the various analytical steps outlined below to calculate results for every pricing point across all segments of the organization.

Margin revenues in each segment at each pricing point are calculated as follows: (1) current margin and current volume for each segment are pulled in as input data, and (2) projected volume corresponding to each pricing point is derived from a demand curve constructed using elasticity coefficients. The projected volume may be derived from the following:

$ Revenue_{Optimal}=Unit Volume₀(1+elasticity coefficient)̂^{(-Price Δ/5 basis points “bps”)}

After projected volumes for each price point change are determined, the corresponding revenue impact may be calculated as:

Revenue=Volume*New Margin/10000

All segments being analyzed may have similar demand curves with different elasticity and “inflection points” based on the demand elasticity model. The optimization engine (as described in further detail herein) may evaluate all pricing points and estimated volumes to maximize the combination of margin revenue within applied constraints. The results for all price point iterations may then be compared to identify final recommended pricing changes that deliver optimal results for the organization.

In addition to the objective function, which in some arrangements may be to “Maximize Revenue,” price optimization modeling may also be based on one or more decision variables, as well as, one or more constraints (e.g., business rules defining limits on how the objective can be pursued) related to numerous internal and external factors of an organization. Such factors may include, for example, market environment changes, changes in public policy, changes in the competitive landscape, competitive position, elasticity, reputation, price parity, and competitive strategic actions. Various other factors, both internal and external to an organization, may also be included in addition to or instead of, those factors mentioned above. The factors considered by an organization may relate to certain characteristics particular to that organization or derive from certain business or marketplace aspects that the organization deems to be more influential than others. The specific constraints described herein only constitute one example of a possible combination of different constraints that may be considered by an organization desiring to implement a strategy of maximizing margin revenue return. Numerous other constraints or combinations thereof may be used in addition to or instead of those described.

### Decision Variables

In one or more arrangements, three primary decision variables may be included in the price optimization model described herein: (1) Relative Strength Index (RSI), (2) Variable Contribution Margin (VCM), and (3) Price Elasticity Coefficients.

1. Relative Strength Index

Relative Strength Index (RSI), as used herein, is a measurement of an organization's pricing position relative to other relevant competitors in the organization's market. For a given product or product group, RSI may be defined as the daily average of all note rate pricing variances across all competitors in the organization's market, weighted by consideration share and note rate selection propensity. In at least one arrangement RSI may be calculated as follows:

RSI=Σ((Price_{c}−Price_{org})*CS_{c}*NRSPₙ)

Where:

c=1 to # of competitors

n=1 to # of note rates in stack

org=organization determining RSI

CS=the consideration share of a given competitor

NRSP=the Note Rate Selection Propensity for a given note rate

Each of the three main inputs to the RSI calculation described above—Daily Competitor Pricing (Price), Consideration Share (CS), and Note Rate Selection Propensity (NRSP)—serve a variety of purposes in measuring the organization's pricing position. For example, including daily competitor pricing allows for real-time comparison of the organization's pricing scheme to the pricing of various competitors, and also enables the organization to capture the most relevant credit scenario by channel, product, loan purpose, and state that most accurately represents the current conditions of the organization's finances. Consideration share weights serve as a proxy probability that borrowers/brokers/correspondents (e.g., customers of the organization) will select a given competitor in the market relative to other competitors. Accordingly, including consideration share in the RSI calculation assigns some degree of relevance to the organization's competitors and allows a weighted average “market par rate” to be calculated. Additionally, incorporating NRSP relative to the market par rate into the RSI calculation serves to estimate the probability that borrowers will select a given note rate from all available note rate options.

Calculating RSI based on daily competitor pricing, consideration share and NRSP also involves reliance on one or more assumptions. For example, with regard to daily competitor pricing, RSI uses default credit scenarios (e.g., Fair-Isaac Corporation (FICO), Loan To Value (LTV), etc.) for each channel, product, loan purpose, state and the like, and also assumes that pricing data is available at the credit scenario level (channel, product, FICO, LTV, purpose, property type, occupancy, etc.). Also, using NRSP in the RSI calculation is based on the assumption that loan level originations data may be used to obtain the rate selected relative to the par rate, and also that historical pricing data (e.g., buy-up/buy-down curves) are available for use at the base level of granularity for the organization's products.

Additionally, each of the main inputs described above factor in to the RSI decision variable calculation in different ways. For example, with respect to the daily competitor pricing input, the price variances at each note rate relative to each competitor (e.g., better or worse) may serve as the baseline components for the RSI calculation. Further, the RSI calculation may employ a significance test to ensure that the calculated value is not based on “thinly” traded price points and, for a given note rate, a minimum number of lenders may be required to publish a price in order for the note rate to be included in RSI. As described above, consideration share assumptions are used to weight the price variances by competitor at each note rate. In one or more arrangements, consideration share may also be used to determine the market par rate.

At a base level, RSI may be calculated each day for a default credit scenario by channel, product, loan purpose, and geographic state as follows:

Step 1: For each note rate, determine whether there are a significant number of relevant competitors (i.e. competitors that have associated consideration share. Significant /minimum competitors may vary by channel) that publish price at the note rate.

Step 2: Consideration Share (CS) weighting, which is described in greater detail below, for qualifying competitors from Step 1 is normalized to a 100% scale as follows (where c=1 to # of qualifying competitors):

NormCS_{c}=CS_{c}/Σ(CS_{c})

Step 3: NRSP weighting for qualifying note rates from Step 1 (i.e. note rates that pass the significance test/meet the minimum competitor threshold) is normalized to a 100% scale as follows (where n=1 to # of qualifying note rates):

NormNRSPₙ=NRSPₙ/Σ(NRSPₙ)

Step 4: A weighted average price variance at each note rate may be calculated using the note rate specific pricing variances of qualifying competitors from Step 1 and normalized consideration share weights as follows (where c=1 to # of competitors):

WgtAvgPriceVar_{NoteRate}=Σ((Price_{c}−Price_{org})*NormCS_{c})

Step 5: All note rate weighted average price variances are then weighted by the normalized NRSP for the given note rate to arrive at the RSI value as follows (where n=1 to # of note rates in stack):

RSI=Σ(WgtAvgPriceVarₙ*NormNRSPₙ)

Consideration share weighting may include competitor volume/consideration share data being compiled at the state level across loan purposes and origination channels for conforming, non-conforming, and government products. Origination channel allocations may then be applied to the product/state level volume consideration share values, thereby creating product/state/loan purpose level consideration share by competitor and by origination channel.

In at least one arrangement, the weekly RSI values may be developed with weighted averages by using the following criteria: (1) state level weekly RSI is the weighted average of the daily RSI, (2) centralized sales uses both Full Spectrum Lending (FSL) and Business-to-Consumer (B2C) volumes for weighting, (3) for all channels, all commit periods are used, and (4) weighting volumes from the FMDM database used to assign weight to each daily RSI value are based on rolling 30 day lookback periods.

The RSI calculation is useful for a number of purposes, including optimization (e.g., using the optimization engine in accordance with aspects of the disclosure), executive summary reporting, tactical reporting and analytical tools, regression modeling and elasticity determinations, and performance measurement techniques. According to various aspects described herein, a change in the RSI control variable may create a corresponding change to volume and/or market share. The impact on volume and/or market share due to an RSI change varies for each segment depending on the elasticity variable for that segment. For a given market share goal, the optimized RSI position is identified to maximize margin revenue. In one or more arrangements, for a state/product/loan purpose/note rate combination to be included in the RSI calculation, a minimum number of competitors (e.g., typically three competitors; however, threshold varies by channel) must publish a price at the given price point.

In accordance with various aspects described herein, it is assumed that the organization's competitors have no time to respond to the organization's pricing change strategies, and, therefore, the change of price is the same as the change of RSI. This assumption provides the basis for the control variable in the price optimization method and system described herein. Additionally, where products may be categorized into product groups, the RSI for each product group may be considered as the volume weighted average of product RSI in the group.

2. Variable Contribution Margin

Variable Contribution Margin (VCM), as used herein, is the revenue margin per loan. Managing to a VCM allows the organization to efficiently utilize price to reduce direct production costs. Conversely, if the organization were to manage strictly to net revenue, margin could be influenced only by a change in volume and a change in price and/or fees. Price may be used as a lever to increase volume or shift the combination of price/volume, which ultimately has a downstream impact on direct production costs. For example, considering Retail versus Banking Center or Purchase versus Refinance, the net revenue between each pair may be similar, though the cost to produce each may be materially different, thus causing an incomplete business decision.

Contribution Margin may be utilized to more clearly show how cost-behavior impacts profitability. Contribution Margin may also be utilized to pinpoint exact price points that must be achieved to cover variable costs and then contribute toward covering fixed costs, ultimately creating profits for the organization. As such, Contribution Margin may be used in conjunction with Price Elasticity (described below) in defining a true profit maximizing price optimization strategy.

In at least one arrangement, Projected VCM may be calculated as follows:

Projected VCM=((lock_NPM_bps*tq_lock_{—}amt/10000)+(Funded PE Proxy* lock_{—}amt/100)+(Fee Proxy*lock_{—}amt/100))+(Variable Cost 1+Variable Cost 2)

The various elements included in the above calculation, including “lock_NPM_bps,” “tq_lock_amt,” “Funded PE Proxy,” “lock_amt,” and “Fee Proxy” are values sourced from loan level data and/or regularly generated finance forecasting reports.

In the Projected VCM calculation above, there are two variable costs. “Variable Cost 1” is the cost that is attributed as a percentage of the loan amount and “Variable Cost 2” is a fixed (Variable) expense attributed to the loan. These two costs are applied on the loan level and may be differentiated by: (1) Legacy organization, (2) Channel, and (3) Government vs. Non-Government products. The following is an illustrative example of determining the two variable costs described above:

3. Price Elasticity

Price elasticity is used to measure consumers' response, as measured in terms of market share, to a change in the organization's competitive position within the marketplace, and is a key component of the price optimization process disclosed herein. For example, price elasticity provides a reliable estimate of market share and/or volume change in response to price changes by the organization, and may also yield a significant competitive advantage through an integrated decision-making process. Additionally, price elasticity may be used to assist in business case development and for different scenario analyses, as described in greater detail below.

According to one or more aspects described herein, elasticity coefficients are derived using statistical modeling to estimate the historic relationship between market share and RSI. Assuming market size is constant, this relationship is used as a key input in the price optimization model described herein to predict how much volume (and therefore market revenue) may change due to a change in price implemented by the organization. The basic formula is the following:

Price Elasticity=% Change in Market Share/For 5 Basis Points Change in RSI
or; assuming market size is held constant,

Price Elasticity=% Change in Organization's Volume/For 5 Basis Points Change in RSI

Elasticity is measured for every incremental change in competitive price position; market share (volume) grows/contracts by x %. As the competitive price position improves, measured by RSI, the demand for a product increases. Likewise, as the competitive price position improves, total revenue increases to the optimal point (in this case 0 RSI). Diminishing returns are experienced as competitive price position continues to improve.

Price elasticity may be calculated at the channel/product, type/product group level for product groups with RSI data available, and also may be calculated on both national and state levels to help determine the optimal price position. In one arrangement, price elasticity coefficients are updated bi-weekly using a Learning Elasticity Adjustment Dashboard (LEAD) process that coincides with bi-weekly elasticity and optimization governance meetings between various divisions of the organization.

In at least one embodiment of the present disclosure, linear regression models are the basis for the initial elasticity coefficients input to the optimization engine. For example, a linear regression model may be developed as market share=f(RSI, Price Exception Usage, Sales Associate Count, Marketing Spend, Product Rollouts, Holidays, Major Weather Events, etc.).

Various aspects described herein relate to providing an organization with a system for measuring, updating and adjusting elasticity coefficients using a learning elasticity adjustment dashboard (LEAD). In one arrangement, an elasticity status (e.g., green, yellow, red, etc.) is determined each week for each segment defined for the optimization process. The elasticity status for each segment may be rolled up using LEAD and reviewed on a periodic basis (e.g., weekly) by one or more levels or individuals of the organization. In one example, elasticity status may be based on the four-week rolling percent error of ((Actual Market Share−Predicted Market Share)/Actual Market Share)*100 and calculated based on the following criteria:
Green: within ±1 Moving Range of 4-week avg. error mean
Yellow: between ±1 and ±2 Moving Range of 4-week avg. error mean
Red: outside ±2 Moving Range of 4-week avg. error mean

For example, if there are two consecutive weeks of the percent error (e.g., four week rolling average) for a given segment in non-green status in the same direction and with the same market environment, an adjustment may be triggered in the elasticity coefficient for that segment. In some arrangements, the amount of such adjustment is limited to 0.5%, and further adjustment will not occur until the trigger condition is met again. Also, the entire demand curve for the specific market environment may be adjusted by the same amount as the curve for that particular segment. In other arrangements, if national segment volume for four consecutive weeks is less than forty total locked units, or state-level segment volume is less than twenty total locked units, then no elasticity status-triggered adjustment will be made. In still other arrangements, the state-level elasticity may required to be within ±1% of the national elasticity for the same product group in the same RSI range, and if there is a national elasticity coefficient available for a product group then all states will have an elasticity coefficient available for that product group. Additionally, in one example, if there is sufficient state level volume for a particular segment, then the state elasticity will be allowed to adjust itself (within a bound of ±1% of national elasticity). If the state does not have sufficient volume to adjust itself, the state will instead follow the national coefficient.

### Constraints

In addition to the objective function and decision variables described above, price optimization modeling may also be based on one or more constraints (e.g., business rules defining limits on how the objective can be pursued) related to numerous internal and external factors of an organization. In general, a constraint may be characterized as either a business constraint or a system constraint. In one arrangement, there are seven types of business constraints defined for the price optimization model, including Reputation (Headline Risk), Margin Floors/Ceilings, Channel Pricing Parity, Purchase/Refinance Pricing Parity, Stability, and Capacity.

The Reputation or Headline Risk constraint may be that for a particular sales channel/product type combination, the optimized RSI must be greater than or equal to a certain basis points value. For example, with regard to the Retail—Centralized Sales Channel (ECOMM), Conforming 30Y Fixed product, Refinance transaction types for all states, the optimized RSI must be greater than or equal to −90 basis points (bps). For a given product of the organization, the Margin Floors/Ceilings constraint may be the minimum/maximum Gross Profit Margin (GPM) allowed per product for that particular product. The Channel Pricing Parity constraint, which is the relationship between Distributed Retail and Centralized Sales channels, may be that the Centralized Sales segment price cannot be more than 25 bps worse than the Distributed Retail segment price or better than Distributed Retail segment price. Similarly, the Purchase/Refinance Pricing Parity constraint may be that, for the same product, in same state, with same purpose, Refinance transaction types cannot have a better price than Purchase transaction types. The Stability constraint may be that the daily price change is limited to within ±25 bps and the weekly price change is limited to ±50 bps, while the Capacity constraint is that the daily capacity is limited by the fulfillment facility of the organization.

To complement the example business constraints identified above, there may also be one or more system constraints. In one arrangement, a system constraint may be that a segment RSI cannot be outside of the determined demand elasticity limits for that segment. A second possible system constraint may be that inactive segments of the organization will be included in the price optimization process to ensure that total revenue is accurate, but these inactive segments receive a recommended price change of $0.

It is to be understood that various other combinations of business and system constraints may be utilized in addition to or instead of those described above. For example, the particular constraints utilized by an organization may be dependent upon review and approval by one or more committees or departments of the organization. Additionally, both business and system constraints may be updated by the organization as needed to reflect changes in market conditions and/or changes in various aspects of the organization's internal operations.

According to aspects of the disclosure, price optimization modeling identifies the RSI position at which the organization's profit margin and market share are optimized, while conforming to a group of defined constraints, such as those outlined above. The optimization model also identifies the cost to grow market share (and the most efficient manner—i.e., product, channel, etc.) as well as the cost of not operating at the optimal point. Each model utilized in the price optimization method described herein may be defined as a “Scenario” according to different combinations of constraints applied. For example, Scenarios used as input to the optimization engine may include “Fully Constrained,” “Fully Constrained without Stability,” “Fully Constrained with Flexible Capacity,” “Fully Constrained with Adjusted Channel Parity,” and “Not Constrained.”

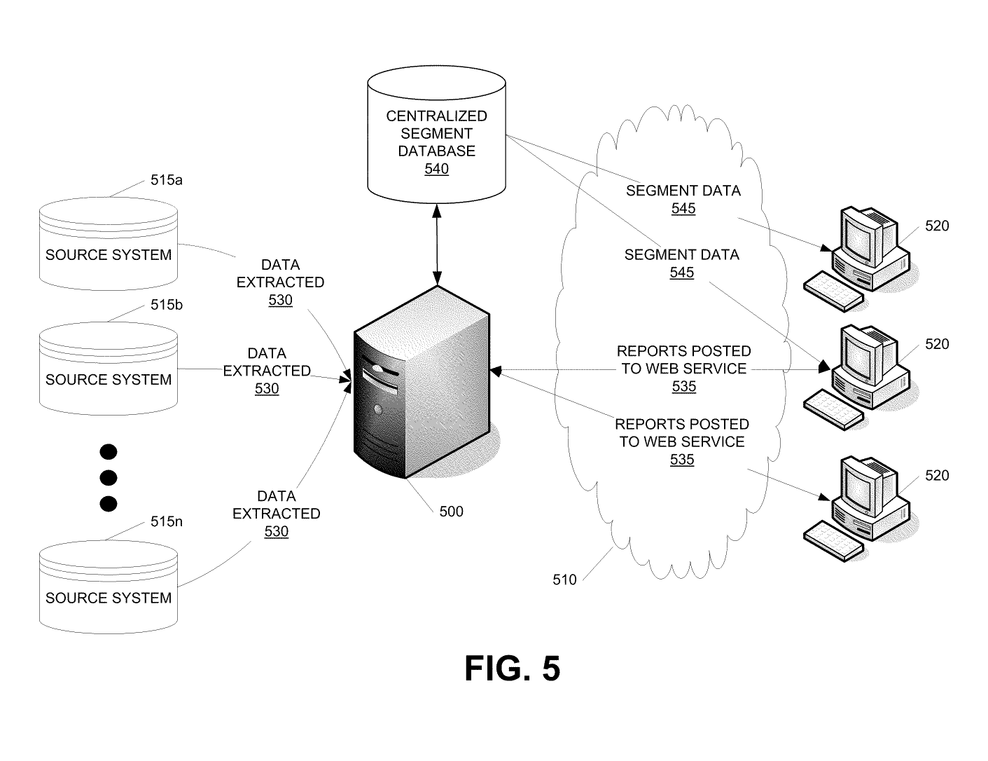

Referring once again to FIG. 4, the price optimization method and system illustrated therein may utilize several data inputs, which, in one or more embodiments of the disclosure, may include the metrics described above such as market share 405, RSI 410, revenue and volume 415, elasticity 420, and initial pricing 425. In the extract and merge current data step 430, the datasets associated with such metrics may be extracted from one or more source systems by the optimization engine, as described in further detail below with reference to FIG. 5.

FIG. 5 illustrates an example data flow for providing automated data extraction and report generation according to one or more aspects of the present disclosure. As shown in FIG. 5, various source systems 515a, 515b and 515n (where “n” is an arbitrary number) are provided from which data may be extracted 530 for input into optimization engine 500. Source systems 515a through 515n may each provide different data types for input into optimization engine 500 or, in alternative arrangements, one or more of source systems 515a through 515n may provide overlapping data for input into optimization engine 500, in which case such overlapping data may be reconciled as part of the data completeness check (e.g., waterfall process step 440 illustrated in FIG. 4) described in further detail below. In one or more embodiments, data extraction 530 from sources systems 515a through 515n may be an automated subprocess comprised within the extract and merge current data 430 step of the price optimization method illustrated in FIG. 4. For example, referring to FIG. 4, data associated with any of market share 405, RSI 410, revenue and volume 415, elasticity coefficients 420, and initial pricing 425, may be extracted from any one or more of sources systems 515a through 515n. Additionally, such data may be extracted 530 from source systems 515a through 515n according to a predetermined schedule (e.g., daily, weekly, etc.) that may be based, in part, on how often such data is refreshed or updated within the source systems. Further, data extracted from source systems 515a through 515n may be in any number of different formats and/or types, including, for example, monetary data, date or time data, character data, numeric data, and the like.

As noted above, various aspects of the disclosure relate to providing an optimization engine to determine an optimized pricing position for the organization. In at least one arrangement, the optimization engine employs statistical analysis software/operations (SAS/OR®) to determine the optimized pricing position through a process that has been translated from various business rules, formulas, and goals developed by the organization.

According to one or more aspects of the disclosure, the optimization engine conducts input data curve analysis as part of the price optimization method described herein. Curve analysis is considered a component of the pricing optimization strategy in which the balance between revenue and market share growth is analyzed while taking into account business level constraints. In one arrangement, the curve may be a function of demand elasticity, competitive position, market share (volume), and revenue (variable contribution margin). In such an arrangement, elasticity is measured for every incremental change in competitive position and market share (volume) grows/contracts by “x” % (where “x” represents an arbitrary number) for every 5 bps price movement. As the competitive position improves, as measured by RSI, the demand for a product increases and total revenue increases to the optimal point. Diminishing returns are experienced as competitive position continues to improve, though market share (volume) increases.

For purposes of illustrating various aspects of the curve analysis performed by the optimization engine, the following constraints (as defined in the brackets following each named constraint) may be applied:
Headline Risk [Optimized RSI >−90 for CF30 product, Refinance, eCommerce]
Channel Pricing Parity [Centralized Sales can be priced better than Distributed Retail by a maximum of 25 bps, Distributed Retail can be priced better than Centralized Sales by a maximum of 25 bps]
Purchase/Refinance Spread [Refinance cannot be priced better than the Purchase price]

The example methodology described below is intended to illustrate aspects of the optimization engine in relation to price optimization. It is to be appreciated that the methodology employed by the optimization engine may change in one or more ways as market conditions vary and as the organization's pricing strategy evolves.

First, two data curves are built. One data curve may be built for the Distributed Retail and Centralized Sales channels combined (DTC) and a second curve built for Wholesale. In at least one embodiment, up to twenty-nine scenarios are created to build each curve, with each scenario representing one point on that curve. The following are various aspects of the curves as they relate to the scenarios that are incorporated into their construction:
M=maximize VCM $ (Fully Constrained). This is the maximum point of the curve and it is similar to the weekly BRAVO output file (Curves does not include Stability Constraint or Margin Floor Constraints).
50=maximize VCM $ at 50% the actual volume. This means that if the actual volume is $100 million and the market share is 25%, then 50% of the actual volume would equal $50 million and market share equal 12.5%.
55=maximize VCM $ at 55% the actual volume.
60=maximize VCM $ at 60% the actual volume.
100=maximize VCM $ at 100% the actual volume.
185=maximize VCM $ at 185% the actual volume.

In certain arrangements where actual volume may not be capable of being expanded beyond a certain limit because of, for example, demand elasticity upper and lower limit values, then one or more scenarios will become unfeasible and will not be appended to the output of the optimization process.

Price Optimization Execution with Optimization Engine

One or more aspects relate to utilizing two main phases in the optimization approach implemented through the optimization engine described herein: “Unconstrained” and “Constrained.” In the unconstrained phase of the optimization process, characterized by no constraints applied among segments, there are also no bindings among segments. Rather, each segment is independent such that the maximum output among combined segments is equivalent to the maximum output of each individual segment, thereby producing the optimized price for each segment. The outputs generated from these individual segment runs are merged and the Maximum Revenue and/or Maximum Volume and Pricing Changes from each segment form the initial points for the subsequent constrained scenario processing phase. It should be noted that even though the first phase of the optimization execution process is referred to as the “unconstrained” phase, individual system constraints are applied to each segment. For example, RSI for a given segment cannot be outside of demand elasticity limits and, further, inactive segments are included in the unconstrained phase to ensure the accuracy of the total revenue calculation, but they receive a recommended price change of $0.

Additionally, the unconstrained optimization execution phase occurs within the following limits:
Max Running Time: 50 mins.
Max Iterations: 3000
Optimization Tolerance: 1E-08

In the second part of the optimization approach implemented through the optimization engine described herein, which may be referred to as the constrained phase, all segments not excluded during the “Waterfall Process” described above are optimized within the constraints for a single scenario definition. As mentioned, excluded segments are still utilized in the constrained phase of the process, but only for purposes of meeting both the Channel Parity and Refinance/Purchase constraints. The constraints that operate within this second phase of the optimization execution process bind the segments, and no one segment is superior to another. In other words, for example, the Refinance segment may be optimized first, with the Purchase segment following the Refinance segment's pricing position or, alternatively, the Purchase segment may be optimized first, with the Refinance segment following Purchase segment's pricing position.

In accordance with one or more aspects described herein, the optimization engine determines the optimal combination of price and volume with which to maximize the objective function for a given segment. In particular, the goal of a constrained scenario optimization execution, as described above, is to provide an overall optimized pricing solution for the submitted segment's objective within that segment's scenario constraints.

As mentioned, the particular constraints applied to a given segment's optimization run are defined by the scenario being executed by the optimization engine. In at least one arrangement, the constrained optimization phase executes within the following limits:
Max Running Time: 50 mins.
Max Iterations: 3000
Optimization Tolerance: 1E-04

### Constraints

In at least one arrangement, there are seven business constraints that may be defined for use in the Optimization Engine, the constraints designed to reflect the nine business rules implemented therein and described above. As will be described in greater detail below, these business constraints may be grouped together in various combinations, referred to herein as “Scenarios,” to produce optimized pricing recommendations. For purposes of illustration, the business constraints for the Consolidated Retail channel of products include:
(1) Reputation: Headline Risk Assessment. In at least one arrangement, the headline risk assessment constraint is defined as the average price difference between certain predetermined competitors of the organization for a particular segment (e.g., the segment defined by Retail-Centralized Sales Channel, Conforming 30-year fixed products, Refinance transactions types, and all states) and is applied in the Optimization Engine using RSI, where the optimized RSI must be greater than or equal to −90 bps (RSIₒₚₜᵢₘₐₗ≧−90 bps).
(3) Channel Pricing Parity. The channel pricing parity constraint is defined by the relationship between the Distributed Retail (DR) and Centralized Sales (CS) channels, and restricts the CS segment price from being more than 25 bps better or worse than the DR segment price. With respect to the channel pricing parity constraint in at least one arrangement, for any pair of segments (e.g., two segments defined by the same product groups, same state, same purpose, but for different channels), the following rules may be applied:
   1. If both are “included” in the optimization engine then the optimized pricing position is limited by this constraint and the optimization engine decides the best solution for the pair of segments;
   2. If one is “included” while the other is “excluded”, then the “excluded” segment receives no price change while the “included” segment has to be limited by the price of the “excluded” segment.
(4) Margin Revenue Forecast. The margin revenue forecast constraint applies at the channel level (e.g., Retail) and may be setup as a method based on projected revenue. All products of the organization need to be included in the optimization model regardless of whether the products will actually be optimized. Those products that are not able to be optimized still flow through the optimization execution to properly match total revenue amount. In one arrangement, the margin revenue forecast constraint is not applied at all within the optimization method described herein, at least with respect to Consolidated Retail channels. However, in at least one other arrangement, the margin revenue forecast constraint is applied, with projected revenue being defined as the following:

Net Profit Margin (NPM)±Price Exception (PE) and Fees
(5) Margin Floors: The margin floors constraint applies at the segment level and is defined as the minimum Gross Profit Margin (GPM) allowed per product.
(6) Stability. The stability constraint applies to the Retail and Wholesale segment levels and limits the maximum weekly price change to ±50 bps and the maximum daily price change to ±25 bps.
(7) Refinance/Purchase. The refinance/purchase pricing parity constraint applies at the channel level (e.g., Retail) and provides that for the same product, same state, and same purpose, Refinance loans may not have a better recommended price than that recommended for Purchase loans.

As mentioned, the seven business constraints described above may be grouped into different Scenarios for different channels of business of the organization. For example, the constraints may be grouped into the Scenarios shown in Table 1 for the Consolidated Retail channels, with the objective function for each Scenario being to Maximize VCM:

TABLE 1

| | | | | | Plan | | |
|---|---|---|---|---|---|---|---|
| | Headline | Margin | Pricing | Refi/ | Forecast | Margin | |
| Scenario | Rate | Ceilings | Parity | Purch | Targets | Floors | Stability |
| Fully Constrained | Y | | Y | Y | | Y | Y |
| Fully Constrained Adjusted | Y | | Y | Y | | Y | |
| Stability (No Stability) | | | | | | | |
| Fully Constrained Adjusted | Y | | Y | Y | | Y | Y |
| Capacity (Exclude Capacity | | | | | | | |
| Constraint) | | | | | | | |
| Fully Constrained Adjusted | Y | | | Y | | Y | Y |
| Channel Parity (Exclude | | | | | | | |
| Channel Parity Constraint) | | | | | | | |
| Fully Constrained Adjusted | Y | | Y | | | Y | Y |
| Purchase/Refinance Spread | | | | | | | |
| (Exclude Purchase/ | | | | | | | |
| Refinance Spread) | | | | | | | |
| Unconstrained | | | | | | | |

As another example, for the Wholesale channel of the organization, the constraints may be grouped into the Scenarios shown in Table 2, again with the objective function for each Scenario being to Maximize VCM:

TABLE 2

| | | | | |
|---|---|---|---|---|
| | Margin | Plan Forecast | Margin | |
| Scenario | Ceilings | Targets | Floors | Stability |

| | | |
|---|---|---|
| Fully Constrained Including | Y | Y |
| Stability Constraint (Margin | | |
| Ceilings and Revenue | | |
| Forecast Disabled) | | |
| Unconstrained | | |

Additionally, the optimization execution as described herein may also include a daily capacity constraint, which applies to both Retail and Wholesale channels and defines a capacity limit according to the fulfillment facility involved. For example, capacity limit may be broken down by whether the loan is to be fulfilled by a conventional institution or facility or is to be fulfilled by the government.

As mentioned, one of the main components of any optimization model is the objective function, which as used herein is a method of performance measurement for the entire system that is to be maximized (or minimized) while satisfying all relevant constraints. For example, an organization may define the following two objective functions for maximization using the optimization engine: (1) Maximize Volume and (2) Maximize Margin Revenue. These example objective functions, which will be described in greater detail below, may represent one or more long-term strategic goals of the organization, or may be defined to achieve certain short-term targets.

### The Volume Function

The volume function is the relationship of volume (e.g., the “dependent” variable) and the position of price/RSI (e.g., the “independent” variable), and is used to identify the optimized RSI (pricing) position that results in maximizing margin revenue for the organization. In this example, the volume function uses demand elasticity coefficients in its calculation, where demand elasticity is defined as the percentage change in market share resulting from a 5 bps change in RSI. Following the example, a demand elasticity curve may include five intervals with corresponding demand elasticity coefficients as follows:
Elasticity Coefficient=e1=0 if RSI is in (−150, −108]
Elasticity Coefficient=e2=1.2 if RSI is in (−108, −35]
Elasticity Coefficient=e3=4.6 if RSI is in (−35, 35]
Elasticity Coefficient=e4=1.2 if RSI is in (35, 108]
Elasticity Coefficient=e5=0 if RSI is in (108, 150]

In the given example, it is assumed that the overall market size has remained the same from the previous week and also that competitors of the organization have not had time to react to the organization's pricing changes. Additionally, for purposes of simplifying the given example and understanding the information described, the percentage of market share change is equivalent to the percentage of the organization's volume change, and the percentage change of RSI is equivalent to change of the organization's pricing position.

For each interval in the demand elasticity curve, the volume function is:

Volume₁=Volume₀*(1+Elasticity Coefficient)̂^{(Change in RSI/5 bps)}

The result may be a positive change in RSI, indicating that the price should be lowered, or a negative change in RSI, indicating that the price should be increased. With a lower price, the positive change in RSI will lead to higher volume (e.g., market share, assuming market size is not changing significantly each week); while with an increase in price, the negative change in RSI will lead to lower volume.

The volume function described above confirms the symmetric impacts of changes in RSI—if the RSI position is decreased by “X” bps and then the RSI position is improved by the same “X” bps, the resulting volume will migrate back to its original condition. The following example further illustrates this symmetrical nature of RSI.
When RSI=0,
Volume₁=Volume₀*(1+e1)̂^{((optimized RSI-(-108))/5 bps)}*(1+e2)̂^{((-108-(-35))/5 bps)}*(1+e3)̂^{((-35-0)/5 bps)} if RSI is in (−150, −108];
Volume₁=Volume₀*(1+e2)̂^{((Optimized RSI-(-35))/5 bps)}*(1+e3)̂^{((0-(-35))/5 bps)} if RSI is in (−108, −35];
Volume₁=Volume₀*(1+e3)̂^{((Optimized RSI-0)/5 bps)} if RSI is in (−35, 35];
Volume₁=Volume₀*(1+e3)̂^{((35-0)/5 bps)}*(1+e4)̂^{((Optimized RSI-35)/5 bps)} if RSI is in (35, 108];
Volume₁=Volume₀*(1+e3)̂^{((35-0)/5 bps)}*(1+e4)̂^{((108-35)/5 bps)*(}1+e5)̂^{((Optimized RSI-108)/5 bps)} if RSI is in (108, 150];

As shown in the above example, the volume function is an incursive function, and there may be different functions depending on the potentially optimized RSI location and the current RSI location.

Additionally, the following numerical examples help illustrate the logic that may be used to calculate the volume for each RSI point included in a demand elasticity curve, assuming an initial point of RSI=0 and Volume=100:
When RSI>−35 and RSI<=35, e=4.6%; V=(1+4.6%)̂[(RSI−0)/5]*100;
   V=(1+4.6%)̂(30/5)*100=131 when RSI=30;
   V=(1+4.6%)̂(−30/5)*100=76 when RSI=−30;
When RSI >35 and RSI <=108, e=1.2%; V=(1+1.2%)̂[(RSI−35)/5]*(1+4.6%)̂[(35−0)/5]*100;
   V=(1+1.2%)̂[(90−35)/5]*(1+4.6%)̂[(35−0)/5]*100=156 when RSI=90;
When RSI <−35 and RSI >=−108, e=1.2%;
   V=(1+1.2%)̂[(RSI+35)/5]*(1+4.6%)̂[(−35−0)/5]*100;
   V=64 when RSI=−90;

To calculate the volume when the initial point is RSI=30 and Volume=131:
When RSI moves to 90, V=(1+4.6%)̂((35−30)/5)*(1+1.2%)̂((90−35)/5))*131=156; and
When RSI moves to −90, V=(1+4.6%)̂((−35−30)/5)* (1+1.2%)̂((−90+35)/5)*131=64.

It should be noted that there is always the same volume for the same RSI, regardless of the initial RSI value.

### Margin Revenue Optimization

In addition to the objective function of maximizing volume, as described above, the second objective function defined for present example is to maximize the profit margin for the organization while meeting the organization's target market share goal. As described in greater detail below, when the objective is to optimize the profit margin, the optimization engine will multiply the optimized volume by margin, thereby building a relationship between the objective and independent variables of the volume function (e.g., RSI/Pricing position). In at least one arrangement, the optimization engine will search (e.g., by executing SAS/OR) all possible positions for RSI/Pricing within a particular interest range (e.g., the interest range that permits the organization to meet any relevant RSI/Pricing related constraints) and calculate the corresponding total profit margin. In doing so, the optimization engine will also verify that the calculated total profit margin meets all constraints, including non-RSI/Pricing related constraints such as capacity constraints. Depending on the convexity of the objective function and the choice variable range, the optimization engine identifies, iteration by iteration, the RSI/Pricing position that maximizes the profit margin for the organization.

Continuing with the present example, defining the margin profit function involves deriving Variable Control Margin (VCM) Basis Points (bps) according to the VCM calculation steps described above. Based on data from the previous week, Projected VCM is calculated in dollars and the projected VCM_bps is calculated as follows:

VCM_BPS_Both=((vcm_{CORP}+vcm_{MORT})/(wk1_vcre_lock_amt+wk1_tq_lock_amt))*10000

In the above calculation, VCM_BPS_Both is, at least in one arrangement, calculated in the extract and merge current data step 430 described above with respect to FIG. 4, and “CORP” and “MORT” represent the organization's corporate operations and the organization's home loans division, respectively. Given any new RSI/Pricing position of the organization, the following is then assumed:

VCM_BPS=VCM_BPS_Both (from previous week's data)+Recommended Change of Price

Margin profit is therefore defined as the following, where “Expected Units” are calculated based on the volume function derived from the demand elasticity curve, as described above, and the average loan amount is the average loan amount of loans belonging to the same defined segment:

VCM (in $$ at new pricing position)=VCM_BPS (at new pricing position)* Expected Units*Average Loan Amt.

### Margin Profit Optimization

In the example described herein, one of the objectives is to optimize the profit margin for the organization, which accomplished through an iterative process executed by the optimization engine. For each segment, the volume is a function of RSI/Pricing position, and VCM is differentiated by channel, product group and purpose. When RSI/Pricing position changes, it is assumed that lock_NPM_bps changes by an identical value as it is also assumed that competitors of the organization have not yet reacted to the organization's price change. As outlined above, at each RSI/Pricing point there is a corresponding total margin profit, and the optimization engine searches (e.g., by executing SAS/OR) all possible positions for RSI/Pricing within an applicable range that satisfies all RSI/Pricing related constraints, if any. From the search, the optimization engine outputs the corresponding total profit margin, which is then verified to ensure compliance with all constraints including non-RSI/Pricing related constraints such as capacity constraints. In an example where a choice must be made among segments due to, e.g., capacity constraints, segments with higher VCM may receive priority since at least one of the goals of the optimization process is to have more volume in the segments with higher VCM. As such, the parameters applied in the VCM calculation described above play a key role in determining the optimized pricing solution.

### Summary File Creation

Upon completion of the optimization process described above, all segments are optimized and in condition for reporting to the organization in any number of ways. FIG. 9 illustrates some of the various ways that the outputs from the optimization engine may be utilized by an organization. For example, as will be described in greater detail below, the active segments that were optimized are appended to the inactive segments dataset to form a single consolidated data set that includes all segments (e.g., “combined_scenario_name”). This consolidated data set may then be used as input to create numerous reports and detailed recommendations for use by the organization in actually implementing its target strategy. For example, the consolidated data may be used to create summary and detailed pricing recommendations files that can be stored in a permanent location on one or more servers accessible to certain employees, departments, divisions, etc., of the organization.

In one arrangement, data in the combined_scenario_name dataset is segment level information (a combination of channel, product group, purpose and state). To create summary data, e.g., summary and detailed pricing recommendations 9**, one or more variables associated with the data may be aggregated while others may be calculated using weighted averages. Table 3 shown below includes example variables that may be utilized in the creation of summary report data as described herein, wherein variables that use the suffix “n_” are the initial segment values, and variables that use the suffix “nf_” are the optimized segment values (e.g., values expected after the price change recommendation is applied).

TABLE 3

| Variable | Weight Variable | Statistic |
|---|---|---|
| n_average_loan_size | n_units | Mean |
| n_avg_rev_loan | | |
| n_margin | n_volume | Mean |
| n_rsi | | |
| nf_elasticity | | |
| v_price_change | | |
| n_units | | Sum |
| n_volume | | |
| n_market_volume | | |
| n_market_units | | |
| n_revenue (vcm) | | |
| n_units_lag | | |
| n_volume_lag | | |
| n_gpm | | |
| n_npm | | |
| n_projectedrev | | |
| n_divisional_pe | | |
| n_pe_proxy | | |
| n_fee_proxy | | |
| n_varcost | | |
| nf_average_loan_size | nf_units | Mean |
| nf_avg_rev_loan | | |
| nf_margin | nf_volume | Mean |
| nf_rsi | | |
| nf_units | | Sum |
| nf_volume | | |
| nf_market_volume | | |
| nf_market_units | | |
| nf_revenue (vcm) | | |
| optimizer | | |
| nf_units_lag | | |
| nf_volume_lag | | |

### Strategy Recommendations

The optimization process and system described herein recommends to an organization an optimal set of permissible actions that will result in the most favorable outcome for the organization in efforts to achieve a particular goal or target objective. For example, the optimization process may be utilized to recommend to a financial institution an optimal combination of price and volume for the institution's mortgage products in support of an overall business strategy for maximizing the institution's total contribution margin. As will be described in greater detail below, once such recommendations have been generated for an organization, the next step is make actual decisions, e.g., pricing decisions, that take the recommendations into account.

The recommendations that are ultimately produced by, e.g., the optimization engine, according to the optimization model described herein may be utilized by an organization in a variety of ways. With reference to a financial institution seeking to use such recommendations in making pricing decisions for its mortgage products the following examples illustrate various considerations involved in the decision-making process:

Example 1: the recommendation from the optimization engine (e.g., optimization engine 500 shown in FIG. 5) is to move loan product “A” to a +50 RSI. The previous week's RSI for loan product “A” was +25, indicating a 25 bps price improvement is needed. However, yesterday's “point in time” RSI for loan product “A” was +60, indicating that a 10 bps worsening is needed to reach the optimized RSI of +50.

Example 2: the recommendation from the optimization engine is to move loan product “A” to a +40 RSI. The previous week's RSI for loan product “A” was +15, indicating a 25 bps price improvement is needed. However, yesterday's “point in time” RSI for loan product “A” was +35, indicating that a 5 bps improvement is needed to reach the optimized RSI of +40.

In one arrangement, two actions may be implemented as pricing decisions and reporting activities on volume and revenue impacts are made by an organization: Financial Impact Calculations and Optimal Pricing Calculations.

The first possible action is referred to as Financial Impact Calculations (or “What-If”). The data contained within the What-If tool is consistent with the data used in the optimization model. However, the What-If tool allows for the input of new information, for example yesterday's “point in time” RSI. The drawback is that the use of new information creates a mismatch of inputs to expected outputs. For this reason, the What-If tool is to be used as a reference and not a replacement for the optimization engine executing the optimization model described herein. The What-If tool has the singular purpose of estimating the financial impact of a pricing move, it does not set targets.

The second action is referred to as Operational Pricing Calculations. In at least one arrangement, the optimization recommendations are based on “lag” data (e.g., the previous week's average RSI, average VCM, etc.), thereby making it necessary to consider more recent data in the pricing decision and execution process. However, this action has no impact on the estimated financial implications of the pricing move. In Example 2 described above, as the market's competitive environment has essentially improved by 35 bps, an additional move of 10 bps is needed (for a total improvement in RSI of 25).

It is to be understood that although the optimized recommendations generated by the optimization engine executing the optimization model described herein are designed to be utilized as input when making various types of decisions, such as pricing decisions, situations may arise where the recommendations need adjusting to account for certain unanticipated factors and/or occurrences. For example, deviations to the recommendations may be necessary for parity disparities, capacity constraints, optimization engine and/or elasticity anomalies, as well as, for meeting certain targets set by the organization.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present disclosure.

We claim:

1. A computer implemented method comprising:
inputting, in a computer, one or more objective functions and one or more business rules associated with the one or more objective functions, the one or more business rules defining limits for the one of more objective functions;
acquiring, by the computer, pricing and volume data for each of a plurality of securities;
identifying, by the computer, excluded and non-excluded securities from the plurality of securities, the non-excluded securities meeting a first criteria and the excluded securities meeting a second criteria different from the first criteria; and
calculating, by the computer, a combination of price and volume for each of the non-excluded securities with which to maximize the one or more objective functions within the limits defined by the one or more business rules, the calculating being based upon the pricing and volume data for each of the non-excluded securities.

2. The computer implemented method of claim 1, further comprising generating, by the computer, one or more data reports based on the calculated combinations of price and volume for the non-excluded securities.

3. The computer implemented method of claim 1, further comprising:
combining, by the computer, the calculated combinations of price and volume for the non-excluded securities with the pricing and volume data for the excluded securities to form a consolidated set of data; and
generating, by the computer, one or more data reports based on the consolidated set of data.

4. The computer implemented method of claim 1, wherein the one or more objective functions includes a function for determining profit margin from a combination of price and volume.

5. The computer implemented method of claim 1, wherein the pricing and volume data includes competitive position measurement and revenue margin data for each of the plurality of securities.

6. The computer implemented method of claim 1, wherein the first criteria is compliance with each of the one or more business rules.

7. The computer implemented method of claim 1, further comprising:
determining, by the computer, that the pricing and volume data for a non-excluded security is insufficient for calculating a combination of price and volume for the non-excluded security, the determining being based upon the pricing and volume data for the non-excluded security and the one or more business rules; and
combining, by the computer, the pricing and volume data for one or more of the excluded securities with the pricing and volume data for the non-excluded security.

8. One or more computer readable media storing computer executable instructions that, when executed by at least one processor, cause the at least one processor to perform a method comprising:
receiving one or more objective functions and one or more business rules associated with the one or more objective functions, wherein the one or more business rules define limits for the one of more objective functions;
receiving pricing and volume data for each of a plurality of securities;
identifying excluded and non-excluded securities from the plurality of securities, wherein the non-excluded securities meet a first criteria and the excluded securities meet a second criteria different from the first criteria; and
calculating a combination of price and volume for each of the non-excluded securities with which to maximize the one or more objective functions within the limits defined by the one or more business rules, wherein the combination of price and volume is calculated based upon the pricing and volume data for each of the non-excluded securities.

9. The one or more computer readable media of claim 8, the method further comprising generating one or more data reports based on the calculated combinations of price and volume for the non-excluded securities.

10. The one or more computer readable media of claim 8, the method further comprising:
combining the calculated combinations of price and volume for the non-excluded securities with the pricing and volume data for the excluded securities to form a consolidated set of data; and
generating one or more data reports based on the consolidated set of data.

11. The one or more computer readable media of claim 8, wherein the one or more objective functions includes a function for determining profit margin from a combination of price and volume.

12. The one or more computer readable media of claim 8, wherein the pricing and volume data includes competitive position measurement and revenue margin data for each of the plurality of securities.

13. The one or more computer readable media of claim 8, wherein the first criteria is compliance with each of the one or more business rules.

14. The one or more computer readable media of claim 8, the method further comprising:
determining that the pricing and volume data for a non-excluded security is insufficient for calculating a combination of price and volume for the non-excluded security, the determining being based upon the pricing and volume data for the non-excluded security and the one or more business rules; and
combining the pricing and volume data for one or more of the excluded securities with the pricing and volume data for the non-excluded security.

15. A system comprising:
at least one database configured to maintain pricing and volume data for each of a plurality of securities; and
at least one computing device, operatively connected to the at least one database and configured to:
receive one or more objective functions and one or more business rules associated with the one or more objective functions, wherein the one or more business rules define limits for the one of more objective functions;
identify excluded and non-excluded securities from the plurality of securities, wherein the non-excluded securities meet a first criteria and the excluded securities meet a second criteria different from the first criteria; and
calculate a combination of price and volume for each of the non-excluded securities with which to maximize the one or more objective functions within the limits defined by the one or more business rules, wherein the combination of price and volume is calculated based upon the pricing and volume data for each of the non-excluded securities.

16. The system of claim 15, the at least one computing device further configured to generate one or more data reports based on the calculated combinations of price and volume for the non-excluded securities.

17. The system of claim 15, the at least one computing device further configured to:
combine the calculated combinations of price and volume for the non-excluded securities with the pricing and volume data for the excluded securities to form a consolidated set of data; and
generate one or more data reports based on the consolidated set of data.

18. The system of claim 15, wherein the one or more objective functions includes a function for determining profit margin from a combination of price and volume.

19. The system of claim 15, wherein the pricing and volume data includes competitive position measurement and revenue margin data for each of the plurality of securities.

20. The system of claim 15, the at least one computing device further configured to:
determine that the pricing and volume data for a non-excluded security is insufficient for calculating a combination of price and volume for the non-excluded security, the determining being based upon the pricing and volume data for the non-excluded security and the one or more business rules; and
combine the pricing and volume data for one or more of the excluded securities with the pricing and volume data for the non-excluded security.
